(19) United States
(12) Patent Application Publication
(10) Pub. No.: US 2023/0198098 A1
(43) Pub. Date: Jun. 22, 2023

(54) SEPARATOR MEMBRANE, SEPARATOR MEMBRANE ROLL, BATTERY CELL, AND POWER LITHIUM BATTERY

(71) Applicants: JIANGSU SENIOR NEW MATERIAL TECHNOLOGY CO., LTD, Jiangsu (CN); SHENZHEN SENIOR TECHNOLOGY MATERIAL CO., LTD., Guangdong (CN)

(72) Inventors: Xiang PING, Guangdong (CN); Chao HUA, Jiangsu (CN); Baocheng ZHONG, Guangdong (CN); Xiaobao YE, Guangdong (CN); Xuemei YANG, Guangdong (CN); Xiufeng CHEN, Guangdong (CN)

(73) Assignees: JIANGSU SENIOR NEW MATERIAL TECHNOLOGY CO., LTD, Jiangsu (CN); SHENZHEN SENIOR TECHNOLOGY MATERIAL CO., LTD., Guangdong (CN)

(21) Appl. No.: 18/000,654

(22) PCT Filed: Jul. 27, 2021
(86) PCT No.: PCT/CN2021/108715

§ 371 Date: Dec. 2, 2022

(30) Foreign Application Priority Data
Jun. 4, 2020 (CN) 202010503541.1

(51) Int. Cl. H01M 50/46; H01M 10/0525; H01M 50/417; H01M 50/449; H01M 50/491

(52) U.S. Cl. CPC H01M 50/461; H01M 10/0525; H01M 50/417; H01M 50/449; H01M 50/491

(57) ABSTRACT

Disclosed are a separator membrane, a separator membrane roll, a battery cell, and a power lithium battery. The separator membrane includes a porous base film and a bonding layer; in a preset direction of the porous base film, the surface of the porous substrate includes a middle blank area, and a coated area at the two ends; the bonding layer is applied on the two coated areas. By means of applying the bonding layer to both ends of the porous base film surface, it is possible, during the process of assembling and forming the lithium battery cell, to cause the bonding layer to contact and bond with the two ends of the negative electrode inside the lithium battery cell, effectively ensuring that the lithium battery bears sufficient tension, pressure, and vibration during assembly, vibration testing, and long-term cycling.

### CROSS-REFERENCES TO RELATED APPLICATIONS

The present application claims the priority of a Chinese patent application filed with the Chinese Patent Office on Jun. 4, 2020, with the present application number 2020105035411, titled as “separator membrane, separator membrane roll, battery cell, and power lithium battery”, the entire content of which is incorporated in the present application by reference.

### TECHNICAL FIELD

The present application relates to the field of lithium ion batteries, and particularly, to a separator membrane, a separator membrane roll, a battery cell, and a power lithium battery.

### BACKGROUND ART

With development of electric vehicles, the requirements for the energy density and safety performance of power lithium batteries are getting higher and higher. From the perspective of the principle of lithium battery technology, currently an important problem to be solved in the lithium battery science and industry is how to effectively improve these two essential performances which are seemingly contradictory to each other.

In a traditional power lithium battery system, the battery cells are assembled into a module, and then the module is installed in a battery pack, so as to form a three-level assembly mode of “cell-module-battery pack”. Here, the design form of combining small single battery cells into a module is limited by the level of battery materials and battery engineering capabilities in the early stage of the industry, and it is difficult to produce large-capacity battery cells with good consistency in large quantities. With the improvement of the level of battery materials and battery engineering capabilities, a development trend of a power battery is to cancel the volume and weight occupied by the module, bypass the module and directly use the battery cells to form the battery pack. The energy density of a lithium battery is greatly improved through the structural optimization. Statistics show that the power battery packs designed with this technology can increase their space utilization by about 20%, reduce the number of related parts by about 40%, and increase the battery production efficiency by about 50%. In this way, the volume and weight, which are saved by omitting the module, can be used to increase the power and improve the battery life. It can be seen that the design mode of directly forming a battery pack with battery cells can have a more streamlined production process and higher production efficiency, and can also greatly reduce the manufacturing cost of power batteries, so that it is an effective engineering solution to improve the overall technology of power batteries. However, behind this kind of engineering solution, a large number of technical problems in structural design and craftsmanship need to be solved urgently.

At present, the battery cells of power batteries are mainly divided into cylindrical, soft package and square batteries in terms of structural design. Without changing the current materials and electrochemical system, in order to realize the increase of the energy density of the system and reduce or cancel modules, the main technical means is to increase the capacity of the single battery cell, which is reflected in changing the size and shape of the single battery cell, including the length, width and thickness of the battery cell. Due to the change of battery size, especially the significant increase of size in the width direction, it will bring about serious technical challenges to the assembly and the stability of long-term use of the battery cell structure. When the large-size power lithium batteries are wound or in a lamination process, the alignment accuracy and stability of the size thereof are a difficult problem in the assembly process. In addition, during the long-term use of the power battery pack, due to influence of vibration and internal local resonance, relative movement is prone to occur between the positive and negative plates of the battery and between the battery cell and the housing, and the welding tabs are prone to be loose or damaged, causing unstable structure and performance. As a result, the battery is prone to be in a state of micro short circuit, self-discharge, internal resistance rise, etc. during production and use, resulting in a low yield and a poor reliability of battery production.

### SUMMARY

The purpose of the embodiments of the present application is to provide a separator membrane, a separator membrane roll, a battery cell, and a power lithium battery.

The present application provides a separator membrane, wherein the separator membrane comprises a porous base film and bonding layers;

each of surfaces of the porous base film comprises, along a preset direction of the porous base film, a blank area in middle and coated areas at both ends; and

the bonding layers are coated on the coated areas at both ends.

Optionally, a size of each of the coated areas along a preset direction is between 2 mm and 15 mm; a size of the blank area along a preset direction is between 50 mm and 1200 mm.

Optionally, a thickness of the bonding layer is in a range of 0.5 μm to 4 μm.

Optionally, the bonding layer is a continuous coating layer or a discontinuous coating layer.

Optionally, the discontinuous coating layer comprises, along a preset direction, a plurality of strip coating layers, dot coating layers, bulk coating layers or curved coating layers spaced from each other.

Optionally, a direction perpendicular to the preset direction is a MD direction; and when the discontinuous coating layer is a strip coating layer, an angle formed between the strip coating layer and the MD direction is between 10° and 170°, but not including 90°.

Optionally, the bonding layers are discontinuous coating layers, and a coverage ratio of the bonding layers in the coated areas is between 10% and 90%.

Optionally, the coverage ratio of the bonding layers in the coated areas is between 40% and 80%.

Optionally, raw material of the bonding layer comprises organic substance;

the organic substance is selected from at least one of polyacrylate, polyacrylic acid, polyacrylate, styrene butadiene rubber, epoxy resin, amino resin, polyamide, polyethyleneimine, polyvinylidene fluoride, polytetrafluoroethylene, polyvinylidene fluoride-hexafluoropropylene copolymer and polyvinylidene fluoride-tetrafluoroethylene copolymer; and optionally, the raw material of the bonding layer further comprises at least one of sodium carboxymethyl cellulose and sodium alginate.

Optionally, the organic substance accounts for 10-100% of a total weight of the bonding layer.

Optionally, raw material of the bonding layer comprises inorganic substance, and the inorganic substance is selected from one or more of aluminum oxide, titanium oxide, zinc oxide, calcium oxide, magnesium oxide, zirconium oxide, and boehmite.

Optionally, a particle size D50 of the inorganic substance ranges from 0.1 to 2.0 μm.

Optionally, in terms of weight percentage, the inorganic substance accounts for 0-90% of the total weight of the bonding layer.

Optionally, the porous base film is of a single layer; and material of the porous base film is selected from one or more of polyethylene, polypropylene, polyethylene terephthalate, polyamide, polyimide, and PET non-woven fabric; or

the porous base film is of a multilayer; and the porous base film is made of polyethylene and/or polypropylene with different molecular weights and different melt indexes.

Optionally, a thickness of the porous base film is in the range of 5 μm to 30 μm.

Optionally, a porosity of the porous base film is in a range of 20% to 70%.

The present application provides a separator membrane roll, which is formed by winding up the separator membrane roll in a direction perpendicular to the preset direction.

The present application provides a battery cell, comprising the separator membrane mentioned above;

a negative plate, wherein the negative plate is arranged on one side of the separator membrane, and both ends of the negative plate are bonded to the bonding layer coated on a surface of the separator membrane; and

a positive plate, wherein the positive plate is located on the other side of the separator membrane, and the positive plate is overlapped with the blank area of the separator membrane.

The present application provides a power lithium battery, wherein the power lithium battery comprises the battery cell mentioned above.

### BRIEF DESCRIPTION OF DRAWINGS

In order to explain the technical solutions of the embodiments of the present application more clearly, the drawings that need to be used in the embodiments will be briefly introduced below. It should be understood that the following drawings only show part of the content of the present application and should not be considered as limitation on the protection scope. For those skilled in the art, other related drawings can be obtained from these drawings without creative efforts.

FIG. 1 is a schematic diagram of the first type of the composite separator membrane provided by the embodiment of the present application;

FIG. 2 is a schematic diagram of a second type of the composite separator membrane provided by an embodiment of the present application;

FIG. 3 is a schematic diagram of a third type of the composite separator membrane provided by an embodiment of the present application;

FIG. 4 is a schematic diagram of a fourth type of the composite separator membrane provided by an embodiment of the present application; and

FIG. 5 is a schematic diagram of a battery cell provided by an embodiment of the present application.

### REFERENCE NUMBERS

100—porous base film; 200—bonding layer; 101—blank area; 201—bonding layer; 102—blank area; 202—bonding layer; 103—blank area; 203—bonding layer; 104—An empty area.

### DETAILED DESCRIPTION OF EMBODIMENTS

In order to make the purpose, technical solutions and advantages of the embodiments of the present application clearer, the technical solutions in the embodiments of the present application will be clearly and completely described below with reference to the drawings in the embodiments of the present application. Obviously, the described embodiments are part, but not all, of the content of the present application. Generally, the components of the embodiments of the present application described and shown in the drawings herein may be arranged and designed in various different configurations.

Therefore, the following detailed description of the embodiments of the present application provided in the drawings is not intended to limit the scope of the claimed application, but merely represents a part of the content of the present application. Based on the embodiments in the present application, all other embodiments obtained by those skilled in the art without creative work shall fall within the protection scope of the present application.

In addition, the terms “first”, “second”, “third”, etc. are only used to distinguish descriptions, and cannot be understood as indicating or implying relative importance.

The embodiments of the present application provide a separator membrane, which comprises a porous base film and bonding layers.

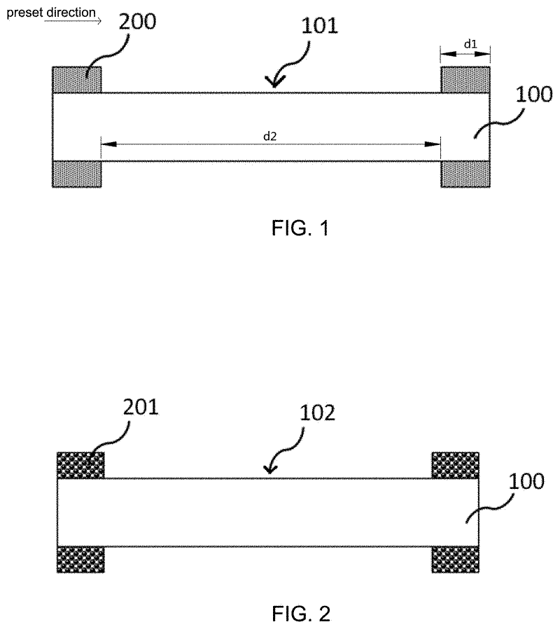

Along the preset direction of the porous base film (the arrow direction in FIG. 1), each of the surfaces of the porous base film comprises a middle blank area and coated areas at both ends.

The bonding layers are coated on the coated areas at both ends.

The separator membrane, through coating the bonding layers onto both ends of the porous base film, can make the bonding layers come into contact and bond with both ends of the negative plate inside the lithium battery cell during the assembly and molding process of the lithium battery cell. The bonding layers can also be bonded with each other. Therefore, the separator membrane can make the plates of the battery fix in position and be compact, so that the plates of the battery and the separator membrane are integrated. Especially for large-size power lithium batteries, it can effectively ensure that the lithium battery can withstand sufficient tension, pressure and vibration during assembly, vibration testing and long-term cycling process, and avoid that the relative movement between the positive and negative plates of the battery and between the battery cell and the housing result in adverse consequences, such as, slow yield, micro short circuit, self-discharge, increased internal resistance, and welding tabs being loose or damaged.

Optionally, the porous base membrane is of a single layer. Optionally, the material of the porous base film is selected from one or more of polyethylene, polypropylene, polyethylene terephthalate, polyamide, polyimide, and PET non-woven fabric.

Optionally, the porous base film is of a multilayer. The porous base film is made of polyethylene or polypropylene with different molecular weights and different melt indexes.

Optionally, the porous base film is of a multilayer. The porous base film is made of polyethylene and polypropylene with different molecular weights and different melt indexes. Illustratively, the porous base film has three layers.

Optionally, the thickness of the porous base film is in the range of 5 μm to 30 μm.

Optionally, the thickness of the porous base film is in the range of 6 μm to 28 μm.

Optionally, the thickness of the porous base film is in the range of 10 μm to 25 μm.

Illustratively, the thickness of the porous base film is 15 μm, 18 μm, or 20 μm.

Optionally, the porosity of the porous base film is in the range of 20% to 70%.

Optionally, the porosity of the porous base film is in the range of 25% to 65%.

Optionally, the porosity of the porous base film is in the range of 30% to 60%.

Illustratively, the porosity of the porous base film is 35%, 40%, 45%, or 50%.

Optionally, the raw material of the bonding layer comprises organic substance.

Optionally, the organic substance is selected from at least one of polyacrylate, polyacrylic acid, polyacrylate, styrene butadiene rubber, epoxy resin, amino resin, polyimide, polyethyleneimine, polyvinylidene fluoride, polytetrafluoroethylene, polyvinylidene fluoride—hexafluoropropylene copolymer and polyvinylidene fluoride-tetrafluoroethylene copolymer.

Optionally, the raw material of the bonding layer further comprises at least one of sodium carboxymethyl cellulose and sodium alginate. Exemplarily, at least one kind of the aforementioned organic substance and at least one of sodium carboxymethyl cellulose and sodium alginate are selected to prepare a bonding layer by compounding.

Optionally, in terms of weight percentage, the organic substance accounts for 10-100% of the total weight of the bonding layer.

Optionally, in terms of weight percentage, the organic substance accounts for 15-95% of the total weight of the bonding layer.

Optionally, in terms of weight percentage, the organic substance accounts for 20-80% of the total weight of the bonding layer.

Exemplarily, the bonding layer comprises 100% organic substance.

Optionally, the raw material of the aforementioned bonding layer comprises organic substance and inorganic substance. By adding inorganic substance, the static electricity generated by the bonding layer can be reduced to a certain extent, and some undesirable problems caused by static electricity during use can be solved. However, if too much inorganic substance is added, it will affect the bonding force of the bonding layer.

Optionally, in terms of weight percentage, the inorganic substance accounts for 0-90% of the total weight of the bonding layer.

When the amount of the added inorganic substance is within the above range, it can effectively solve the problem of static electricity during use and ensure a good bonding effect.

Optionally, in terms of weight percentage, the inorganic substance accounts for 5-85% of the total weight of the bonding layer.

Optionally, in terms of weight percentage, the inorganic substance accounts for 10-80% of the total weight of the bonding layer.

Exemplarily, in terms of weight percentage, the bonding layer comprises 20% inorganic substance and 80% organic substance; or the bonding layer comprises 50% inorganic substance and 50% organic substance.

Optionally, the inorganic substance is selected from one or more of aluminum oxide, titanium oxide, zinc oxide, calcium oxide, magnesium oxide, zirconium oxide, and boehmite.

Optionally, the particle size D50 of the inorganic substance ranges from 0.1 to 2.0 μm.

Optionally, the particle size D50 of the inorganic substance ranges from 0.5 to 1.8 μm.

Optionally, the particle size D50 of the inorganic substance ranges from 1 to 1.5 μm.

Exemplarily, the particle size D50 of the inorganic substance is 0.8 μm, 1.2 μm, or 1.4 μm.

Optionally, the size of the coated area along the preset direction (width d1 in FIG. 1) is between 2 mm and 15 mm; and the size of the blank area (width d2 in FIG. 1) along the preset direction is between 50 mm and 1200 mm.

Optionally, the size of the coated area along the preset direction is between 3 mm and 14 mm; and the size of the blank area along the preset direction is between 100 mm and 1100 mm.

Optionally, the size of the coated area along the preset direction is between 4 mm and 13 mm; and the size of the blank area along the preset direction is between 500 mm and 1000 mm.

Exemplarily, the size of the coated area along the preset direction is 5 mm, 8 mm or 10 mm; and the size of the blank area along the preset direction is 200 mm, 400 mm, 600 mm or 800 mm.

Optionally, the bonding layers on the coated areas at both ends are symmetrical and have the same size.

Optionally, the thickness of the bonding layer is 0.5 μm to 4 μm.

Optionally, the thickness of the bonding layer is 1 μm to 3.5 μm.

Optionally, the thickness of the bonding layer is 1.5 μm to 3.0 μm.

Exemplarily, the thickness of the bonding layer is 2.0 μm, 2.5 μm, 2.6 μm, 2.8 μm, or 3.2 μm.

Optionally, the bonding layers are continuous coating layers or discontinuous coating layers.

Optionally, the discontinuous coating layer is coated at intervals along the preset direction. The non-continuous coating layer comprises a plurality of strip coating layers, dot coating layers, bulk coating layers or curved coating layers spaced from each other. For example, a plurality of serpentine-shaped coating layers are coated at intervals.

Referring to FIG. 4, optionally, the direction perpendicular to the preset direction is the MD direction. When the discontinuous coating layer is a strip coating layer, the angle α formed between the strip coating layer and the MD direction is between 10° and 170°, but not including 90°.

Optionally, when the discontinuous coating layer is a strip coating layer, the angle formed between the strip coating layer and the MD direction is between 30° and 120°.

The bonding layers are coated on the ends of the two surfaces of the separator membrane, when coating the winding, since both ends are thick and the middle part is thin, the stress on the ends may be too large after the winding length reaches a certain value. Therefore, the coating layer with discontinuous structure is applied at both ends, which can partially disperse the stress concentrated at the ends and increase the winding length, so as to further increase the efficiency during coating and use, and reduce the manufacturing cost.

Optionally, when the bonding layers are discontinuous coating layers, the coverage ratio of the bonding layers in the coated areas is between 10% and 90%.

Optionally, the coverage ratio of the bonding layers in the coated areas is between 40% and 80%.

Optionally, the coverage ratio of the bonding layers in the coated areas is between 50% and 70%.

Exemplarily, the coverage ratio of the bonding layers in the coated areas is 55%, 60%, 65%, 75%, etc.

When the coverage ratio of the binding layer is too low, the content of the polymer is too small, and the binding force to the two ends of the negative electrode of the lithium battery is too low to effectively perform binding. If the coverage ratio is too high, the stress concentrated at the ends cannot be well dispersed, and the effect of improving the roll length and the use efficiency is not significant. Within the above range of coverage ratio, the stress concentrated at the end can be effectively dispersed, and the roll length and use efficiency can be improved effectively.

Optionally, referring to FIG. 1, a separator membrane is provided. The separator membrane comprises a porous base film 100 and bonding layers 200. Optionally, both surfaces of the porous base film 100 are coated with a bonding layer 200. The bonding layers 200 are coated on both ends of the porous base film 100, and both surfaces are coated with the bonding layers 200. The middle area of the porous base film 100 is a blank area 101. The bonding layers 200 are coated in a continuous coating manner. In FIG. 1, each of the four bonding layers 200 is a continuous-type pure bonding layer, and the width of the blank area is 600 mm. The bonding layers 200 only contain organic substance, and the organic substance is selected from a composition of polyacrylate, sodium carboxymethyl cellulose, polyvinylidene fluoride, and polyvinylidene fluoride-hexafluoropropylene copolymer. The thickness of the bonding layer 200 is 2 um, and the value of its unilateral width is 10 mm. The porous base film 100 is a three-layer polypropylene separator membrane, composed of different molecular weights and different melt indexes.

Optionally, the aforementioned bonding layers 200 can also be coated on only one surface of the porous base film 100.

Optionally, referring to FIG. 2, a separator membrane is provided. It is substantially the same as the separator membrane provided in FIG. 1, except that the bonding layers 201 are continuous-type bonding layers of a mixture of pure polymer and inorganic substance, wherein the proportion of polymer is 80 wt %, the proportion of inorganic substance is 20 wt %, and the width of the middle blank area 102 is 600 mm. The porous base film 100 is a three-layer polypropylene/polyethylene/polypropylene separator membrane, composed of different molecular weights and different melt indexes. The thickness of the bonding layer 201 is 2 um, and the value of its single side width is 10 mm. The organic substance in the bonding layer 201 is selected from the composition of polyacrylate, sodium carboxymethyl cellulose, polyvinylidene fluoride, and polyvinylidene fluoride-hexafluoropropylene copolymer. The inorganic substance is selected from alumina, and its particle diameter D50 is 0.6 um.

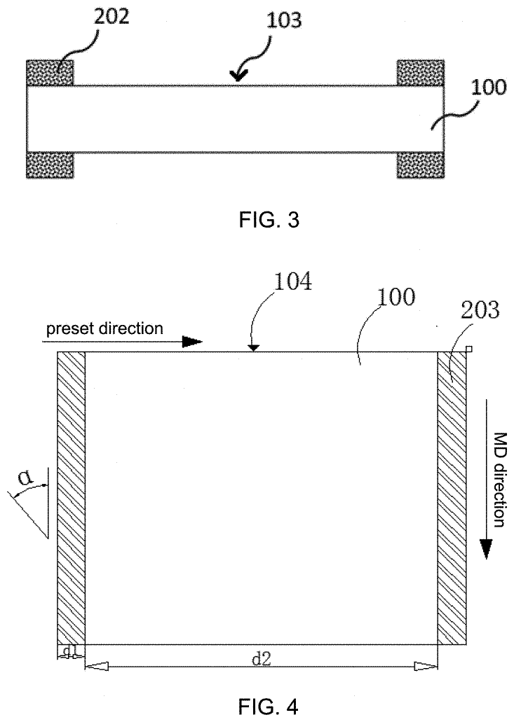

Optionally, referring to FIG. 3, a separator membrane is provided. It is substantially the same as the separator membrane provided in FIG. 1, except that the bonding layers 202 are non-continuous dot pure bonding layer. The coverage ratio of the inside of the film-coated area is 60%, and the width of the blank area 103 is 600 mm. The material of the porous base film 100 is selected from single-layer polypropylene separator membrane composed of different molecular weights and different melt indexes. The thickness of the bonding layer 202 is 1.7 urn, and the value of its single side width is 15 mm. The bonding layer 202 only contains organic substance, and the organic substance is selected from a composition of polyacrylate, sodium carboxymethyl cellulose, polyvinylidene fluoride, and polyvinylidene fluoride-hexafluoropropylene copolymer.

Optionally, referring to FIG. 4, a separator membrane is provided. It is substantially the same as the separator membrane provided in FIG. 1, except that the bonding layers 203 are non-continuous-type strip pure bonding layers. The coverage ratio inside the film-coated area is 60%, the angle α formed between the strip bonding layers and the MD direction of the porous base film 100 is 45°, and the width of the blank area 104 is 600 mm. The material of the porous base film 100 is selected from a three-layer polypropylene separator membrane composed of different molecular weights and different melt indexes. The thickness of the bonding layer 203 is 2.3 urn, and the value of its single side width is 7 mm. The bonding layer 203 only contains organic substance, and the organic substance is selected from a composition of polyacrylate, sodium carboxymethyl cellulose, polyvinylidene fluoride, and polyvinylidene fluoride-hexafluoropropylene copolymer.

The present application also provides a separator membrane roll, which is formed by winding the aforementioned separator membrane in a direction perpendicular to a preset direction.

The present application also provides a battery cell, including the aforementioned separator membrane, negative plate, and positive plate.

The negative plate is arranged on one side of the separator membrane, and both ends of the negative plate are bonded to the bonding layers coated on the surfaces of the separator membrane.

The positive plate is located on the other side of the separator membrane, and the positive plate overlaps with the blank area of the separator membrane.

The bonding layers at both ends of the separator membrane play the role of bonding with the two ends of the negative plates of the lithium battery and the bonding between the bonding layers, so that the battery plates are fixed in position and compact, so that the battery plates and the separator form as a whole. Especially for a large-size laminated battery, it ensures that the lithium battery can withstand sufficient tension, pressure and vibration during assembly, vibration testing, and long-term cycling, and avoids the adverse consequences, such as, low yield, micro-short circuit, self-discharge, increased internal resistance, and welding tabs being loosed or damaged, which are caused by the relative movement between the positive and negative plates of the battery, as well as between the battery cell and the housing.

Optionally, since the bonding layers have no holes, it will affect the transmission efficiency of lithium ions and thereby affect the working of the capacity of material of the positive electrode. The blank area between the two surfaces of the separator membrane provided in the present application is attached to the positive plate, namely, the bonding layers do not contact the active material on the positive plate inside the lithium battery cell, so that it will not affect the transmission efficiency of the battery. The separator membrane does not cause the fact that the assembly of the lithium battery is too complicated. The process cost is low, and it is possible to greatly improve the stability of the inner cell of the battery, and ensure the stability of the lithium battery in long-term cycle.

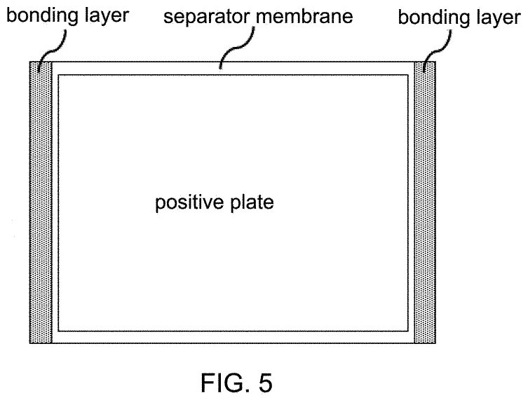

The battery cell can be used to manufacture large-size laminated battery. Referring to FIG. 5, when the battery cell is formed by assembly, the positive plate is located on one side of the separator membrane, and the positive plate is attached to the blank area of the separator membrane (the size of the positive plate is smaller than the size of the separator membrane), and therefore, the positive plate is not in contact with the bonding layers of the separator membrane, so that it will not contact the active material on the positive plate, and will not affect the electrical performance of the battery. The size of the negative plate is the same as that of the separator membrane (it can be set slightly smaller than the separator membrane if necessary). The negative plate is located on the other side of the separator membrane (under the separator membrane, not shown in FIG. 5).

Optionally, the width d1 of each of the bonding layers at both ends of the separator membrane is between 2 mm and 15 mm.

The bonding layers at both ends of the separator membrane firmly bond the separator membrane together with the negative plate, so that the lithium battery can withstand sufficient tension, pressure and vibration during assembly, vibration testing, and long-term cycling process, which avoids the adverse consequences, such as, low yield, micro short circuit, self-discharge, increased internal resistance, and welding tabs being loose or damaged, etc., which are caused by the relative movement between the positive and negative plates of the battery and between the battery cell and the housing.

The present application also provides a power lithium battery, which comprises the aforementioned battery cell.

The power lithium battery, through being provided with the above-mentioned battery cell, enables the large-size power lithium battery to withstand sufficient tension, pressure and vibration during assembly, vibration test and long-term cycling process of the lithium battery cell, thereby improving the long-term cycle performance and battery stability.

The features and performances of the present application will be described in detail below in conjunction with examples and comparative examples.

### Example 1

Provided is a power lithium battery, which is made as follows.

Preparation of a negative electrode is as follows. The graphite, conductive carbon black, thickener sodium carboxymethyl cellulose, and binder styrene butadiene rubber emulsion are added into deionized water at a mass ratio of 96:1:1:2; and it is stirred and dispersed evenly in a mixer, and filtered with a 150-mesh screen to obtain the desired negative electrode slurry, which is then coated, cold pressed, and slit to form a negative plate.

Preparation of a positive electrode was as follows. The lithium iron phosphate, conductive agent, and binder polyvinylidene fluoride are add into nitrogen methyl pyrrolidone (NMP) at a mass ratio of 97:1:2; and it is stirred and dispersed in a mixer, and filtered with a 150-mesh screen to obtain the desired positive electrode slurry, which is then coated, cold pressed, and cut to form a positive plates.

Preparation of electrolyte is as follows. The ethylene carbonate EC, propylene carbonate PC and dimethyl carbonate DMC are used to prepare a mixed solvent according to a volume ratio of 3:3:4, and then relevant additives and lithium hexafluorophosphate (LiPF6) are added wherein the concentration of the prepared LiPF6 was 1M; and the electrolyte is obtained after stirring evenly.

Preparation of the separator membrane is as follows. The polyacrylate, sodium carboxymethyl cellulose, polyvinylidene fluoride, polyvinylidene fluoride-hexafluoropropylene copolymer were added into deionized water at a mass ratio of 6:1:10:83; and it is stirred and dispersed uniformly in a mixer, and filtered with a 150-mesh screen to obtain the desired slurry, and then the slurry is coated on the two end surfaces of one surface of the separator membrane by the gravure coating, and is dried to form a single-side continuous-type pure bonding layer. The base material was a three-layer polypropylene porous base film of 18 um, the thickness of the continuous-type pure bonding layer is 2 um, the width of a single side was 10 mm, and the width of the middle blank area of the separator membrane is 600 mm.

Assembly of the battery is as follows. The above-mentioned negative plate, separator membrane and positive plate are laminated into a battery cell, encapsulated with an aluminum-plastic composite film, and baked in a vacuum state to remove moisture, then the quantitative electrolyte is injected, and the formation and the capacity test are conducted on the battery to obtain a lithium-ion battery in form of square soft packaging, with thickness, width and length of 25 mm, 65 mm, and 610 mm. Here, as for the necessary test items, the battery pack is directly assembled with the battery cells in a certain way.

### Example 2

Provided is a power lithium battery, which is made as follows.

The assembly process of the negative electrode, the positive electrode, the electrolyte, and the battery was the same as in Embodiment 1, except that the separator membrane was different.

Preparation of the separator membrane was as follows. The polyacrylate, sodium carboxymethyl cellulose, polyvinylidene fluoride, polyvinylidene fluoride-hexafluoropropylene copolymer were added into the deionized water at a mass ratio of 6:1:10:83; and it was stirred and dispersed uniformly in a mixer, and filtered with a 150-mesh screen to obtain the desired slurry, and then the slurry is coated onto the two end surfaces of the front and back sides of the separator membrane by the gravure coating, and is dried to form a continuous-type pure bonding layer. The base material was a three-layer polypropylene porous base film, of 18 um, the thickness of the continuous-type pure bonding layer was 2 um, the width of the single side was 10 mm, and the width of the middle blank area of the separator membrane was 600 mm.

### Example 3

Provided is a power lithium battery, which was made as follows.

The assembly process of the negative electrode, the positive electrode, the electrolyte, and the battery is the same as in Example 1, except that the separator membrane was different.

Preparation of the separator membrane was as follows. The polyacrylate, sodium carboxymethyl cellulose, polyvinylidene fluoride, polyvinylidene fluoride-hexafluoropropylene copolymer, and alumina were added into the deionized water at a mass ratio of 6:1:5:68:20, it was stirred and dispersed uniformly in a mixer, and filtered with a 150-mesh screen to obtain the desired slurry, and then the slurry is coated onto the two end surfaces of the front and back sides of the separator membrane by the gravure coating, and make it dried to form a continuous-type bonding layer composed of pure polymer and inorganic substance. The base material is a three-layer polypropylene/polyethylene/polypropylene porous base film of 18 um, the thickness of the bonding layer was 2 um, the width of the single side was 10 mm, and the width of the middle blank area of the separator membrane was 600 mm.

### Example 4

Provided was a power lithium battery, which was made as follows.

The assembly process of the negative electrode, the positive electrode, the electrolyte, and the battery was the same as in Example 1, except that the separator membrane was different.

Preparation of the separator membrane was as follows. The polyacrylate, sodium carboxymethyl cellulose, polyvinylidene fluoride, polyvinylidene fluoride-hexafluoropropylene copolymer were added into the deionized water at a mass ratio of 6:1:10:83, and it was stirred and dispersed uniformly in a mixer, and filtered with a 150-mesh screen to obtain the desired slurry, and then the slurry is coated onto the two end surfaces of the front and back sides of the separator membrane through a gravure roll improved by the engraving area, and is dried to form a non-continuous type point pure bonding layer, wherein the coverage ratio of the inside of the film-coated area was 60%. The base material was a single-layer polypropylene porous base film of 18 um. The thickness of the non-continuous type dot pure bonding layer was 1.7 um, the width of its single side was 15 mm, and the width of the middle blank area of the separator membrane was 600 mm.

### Example 5

Provided was a power lithium battery, which was made as follows.

The assembly process of the negative electrode, the positive electrode, the electrolyte, and the battery is the same as in Example 1, except that the separator membrane was different.

Preparation of the separator membrane was as follows. The polyacrylate, sodium carboxymethyl cellulose, polyvinylidene fluoride, polyvinylidene fluoride-hexafluoropropylene copolymer were added into the deionized water at a mass ratio of 6:1:10:83, and it was stirred and dispersed uniformly in a mixer and filtered with a 150-mesh screen to obtain the desired slurry, and then the slurry is coated onto the two end surfaces of the front and back sides of the separator membrane through a gravure roll improved by the engraving area, and is dried to form a non-continuous type strip pure bonding layer wherein the a coverage ratio of the inside of the film-coated area was 60%, and the angle formed between the strip bonding layer and the MD direction of the porous base film was 45°. The base material was a three-layer polypropylene porous base film of 18 um. The thickness of the non-continuous type strip pure bonding layer was 2.3 um, the width of its single side was 7 mm, and the width of the middle blank area of the separator membrane was 600 mm.

### Comparative Example 1

Provided was a power lithium battery, which was made as follows.

The assembly process of the negative electrode, the positive electrode, the electrolyte, and the battery was the same as in Example 1, except that the separator membrane was different.

The separator membrane was a three-layer polypropylene porous base film with a thickness of 18 um.

### Comparative Example 2

Provided was a power lithium battery, which was made as follows.

The assembly process of the negative electrode, the positive electrode, the electrolyte, and the battery was the same as in Example 1, except that the separator membrane was different.

Preparation of the separator membrane was as follows. The polyacrylate, sodium carboxymethyl cellulose, polyvinylidene fluoride, polyvinylidene fluoride-hexafluoropropylene copolymer were added into the deionized water at a mass ratio of 6:1:10:83, and it was stirred and dispersed uniformly in a mixer, and filtered with a 150-mesh screen to obtain the desired slurry, and then the slurry is coated onto the front and back surfaces of the separator membrane by the gravure coating, and is dried to form a continuous type pure bonding layer with both surfaces being covered fully. The base material was a three-layer polypropylene porous base film of 18 um, and the thickness of the continuous type pure bonding layer was 2 um.

The performances of the lithium ion batteries provided in Examples 1 to 5 and Comparative Examples 1 to 2 were investigated as follows.

1. Electrostatic test on the glued area of the separator membrane: the SIMCO FMX-004 electrostatic field tester was used to test the electrostatic value of the glued area of each test sample. It was repeated 5 times for each group of samples and the average value was calculated.

2. Test on adhesion force between the glued area and the negative electrode of the lithium battery: 5 rectangular splines with 10 mm*200 mm coated area of the separator membrane were obtained by cutting, and the prepared negative plate was cut to obtain 5 rectangular splines of 15 mm*220 mm; one separator membrane and one negative plate were taken, and the glued separator membrane and negative plate are heatedly pressed together under a compound condition of 2.0 Mpa, 90° C., 60 s, and then one end of the negative plate was fixed on the upper clamp of the universal tensile machine and the separator membrane was fixed on the lower clamp of the tensile machine; and the adhesion force between the negative plate and the glued separator membrane was tested at a constant speed of 50 mm/min. It was repeated 5 times for each group of samples, and the average value was calculated.

3. Test on adhesion force between the glued areas: the coated area of the separator membrane was cut to obtain 10 rectangular splines of 15 mm*220 mm; the two identical glued separator membranes were heatedly pressed together through a compound condition of 2.0 Mpa, 90° C., and 60 s, then one end of one of the separator membranes was fixed on the upper clamp of the universal tensile machine, and the other separator membrane was fixed on the lower clamp of the tensile machine; and the adhesion force between the glued separator membranes was tested at a constant speed of 50 mm/min. It was repeated 5 times for each group of samples, and the average value was calculated.

4. Statistics of the battery assembly yield: the statistics were made on the process of preparing lithium-ion batteries by the separator membranes; and the number of finished products in 100 assembled batteries was calculated according to a standard of shipped-product requirement, and the yield rate was calculated.

5. Test on battery cycle performances: taking the lithium ion battery prepared by the separator membrane as a sample, a cycle test was performed on the battery at a charge-discharge rate of 1 C/1 C under an environment of 25° C., and the retention rate of the discharge capacity of the battery at the 1000th cycle group was calculated for each.

6. Vibration reliability test on the lithium battery pack of the power battery based on the ISO12405-1:2011 standard: the random or regular vibration caused by various factors during the use of the power battery was mainly simulated, thereby resulting in reduction of the use performance and stability of the power battery.

The test results are shown in Table 1.

TABLE 1
Test Results of Performance

| | | | | Adhesion | | 1500 | |
|---|---|---|---|---|---|---|---|
| | Separator | Static | Adhesion | between | | cycle | Qualified |
| | membrane | electricity | to | glued | Battery | capacity | rate of anti- |
| | winding | in glued | electrode | areas | assembly | retention | vibration |
| Items | length/m | area/KV | N/m | N/m | yield | rate | performance |
| Example 1 | 1000 | 2.8 | 16 | 32 | 91% | 89% | 93% |
| Example 2 | 1000 | 3.5 | 16 | 32 | 98% | 90% | 99.5% |
| Example 3 | 1000 | 0.7 | 10 | 23 | 99.5% | 89% | 99.2% |
| Example 4 | 2000 | 2.8 | 13 | 27 | 97% | 91% | 98.9% |
| Example 5 | 2000 | 2.4 | 12 | 25 | 98% | 90% | 99.4% |
| Comparative | 2000 | 0.3 | / | / | 85% | 85% | 86% |
| Example 1 | | | | | | | |
| Comparative | 2000 | 3.5 | 16 | 32 | 93% | 50% | 97.8% |
| Example 2 | | | | | | | |

It can be seen from the above test results that for square lithium-ion batteries with a thickness, width, and length of 25 mm, 65 mm, and 610 mm, a critical challenge for reliability and safety in the manufacturing process and long-term use of the lithium battery is to have a larger dimension, especially a longer length. It can be seen from Table 1 that in Comparative Example 1, since the two sides are not coated with glue, the two ends cannot be fixed, and the finished product rate of the battery cells assembly is low, which seriously affects the process efficiency and cost requirements of the battery cell. Secondly, in the follow-up cycle and vibration test, due to phenomena of the short circuit and the micro short circuit caused by the possible relative movement between the positive and negative plates, it leads to the low capacity retention rate and anti-vibration performance at the long-term cycle. For Comparative Example 2, the separator membrane is fully covered with polymer by coating. Due to the presence of a large amount of polymer on the surface of the separator membrane, the conductivity of lithium ions in the normal working state of the lithium battery is seriously affected, and the electrochemical impedance of the battery is also increased, which in turn leads to the degradation of long-term cycle performance. In Example 1, the coating was carried out on both sides, and the adhesion force between the glued area of the separator membrane and the plate and glued area of the negative electrode of the battery is relatively high. However, since only one surface of the separator membrane was coated in the glued area, the fixing effect on the two ends of the long battery cell is not enough. Under extreme conditions of use, the short circuits or the micro short circuits caused by the relative movement between the positive and negative plates are still prone to occur. For Example 2, the separator membrane has been coated with glue on both sides. However, due to its special structure and surface static electricity, the winding length can only be 1000 meters, and otherwise the local deformation caused by excessive stress on the winding end face will occur, which seriously affects the use of the separator membrane in the process of assembling the batteries. Meanwhile, due to the relatively high static electricity on the end face, it is prone to absorb the dust particles in the workshop and affects the smooth spread of the separator membrane during process of assembling the batteries, thus causing that it still cannot meet the requirements for product rate and manufacturing cost control in mass production, although there is larger increase in the rate of finished products of battery assembly. In Example 3, the inorganic oxides are added in the polymer coating formula, under the condition of maintaining a certain adhesion force between the glued area of the separator membrane and plate and glued area of the negative electrode of the battery, since the static electricity on both sides is greatly reduced, the rate of the finished products of the battery assembly can reach more than 99%, which greatly improves the production efficiency and reduces the cost. Meanwhile, due to the better fixing effect at both ends, the structural stability of the battery cell of the lithium battery is guaranteed under normal and extreme conditions. The pass rate of the capacity cycle retention rate and anti-vibration test thereof is relatively high. For Examples 4 and 5, due to the discontinuous-type end-face coating process is used, the stress borne on the glued superimposed area is dispersed during the winding of the separator membrane, so that the winding length of the separator membrane with both sides coated with glue is extended by 1000 meters, which greatly improves the efficiency in the large-scale use process and reduce the cost. Meanwhile, the adhesion force between the glued area of the separator membrane and the plate and glued area of the negative electrode of the battery is also maintained to be at a certain value, achieving the fixing effect of the end face of the long battery cell, so as to achieve, in the test, a good result of the capacity stability and anti-vibration of the battery during long-term cycling of the battery.

Only preferred embodiments of the present application are described above, and which are not intended to limit the present application. For those skilled in the art, the present application can have various modifications and changes. Any modifications, equivalent replacements, improvements, etc. made within the spirit and principle of the present application shall be covered by the protection scope of the present application.

### INDUSTRIAL APPLICABILITY

By using the separator membrane provided by the present application in a lithium battery, the assembly of the lithium battery will not be too complicated, the process cost is relatively low, and the stability of the internal cells of the battery can be greatly improved, thus the stability of long-term cycling of the lithium battery can be ensured.

What is claimed:

1-19. (canceled)

20. A battery cell, comprising a positive plate, a negative plate and a separator membrane, wherein the separator membrane comprises a porous base film and bonding layers;
a surface of the porous base film comprises, along a preset direction of the porous base film, a blank area in middle and coated areas at both ends;
the bonding layers are coated on the coated areas at both ends;
the negative plate is arranged on one side of the separator membrane, and both ends of the negative plate are bonded to the bonding layers coated on a surface of the separator membrane;
the positive plate is located on the other side of the separator membrane, and the positive plate is overlapped with the blank area of the separator;
the preset direction is perpendicular to a MD direction of the separator membrane; and
a size of the coated area along the preset direction is between 2 mm and 15 mm; and a size of the blank area along the preset direction is between 50 mm and 1200 mm.

21. The battery cell according to claim 20, wherein a thickness of the bonding layer is in a range of 0.5 μm to 4 μm.

22. The battery cell according to claim 20, wherein the bonding layer is a continuous coating layer or a discontinuous coating layer.

23. The battery cell according to claim 22, wherein the discontinuous coating layer comprises, along the preset direction, a plurality of strip coating layers, dot coating layers, bulk coating layers or curved coating layers spaced from each other; and
a direction perpendicular to the preset direction is set as a MD direction; and an angle formed between the strip coating layer and the MD direction is between 10° and 170°, but not including 90°, when the discontinuous coating layer is a strip coating layer.

24. The battery cell according to claim 22, wherein the bonding layer is a discontinuous coating layer, and a coverage ratio of the bonding layer in the coated area is between 10% and 90%.

25. The battery cell according to claim 24, wherein the coverage ratio of the bonding layer in the coated area is between 40% and 80%.

26. The battery cell according to claim 20, wherein raw material of the bonding layer comprises organic substance; and
the organic substance is selected from at least one of the group consisting of polyacrylate, polyacrylic acid, polyacrylate, styrene butadiene rubber, epoxy resin, amino resin, polyamide, polyethyleneimine, polyvinylidene fluoride, polytetrafluoroethylene, polyvinylidene fluoride-hexafluoropropylene copolymer and polyvinylidene fluoride-tetrafluoroethylene copolymer; and optionally, the raw material of the bonding layer further comprises at least one of the group consisting of sodium carboxymethyl cellulose and sodium alginate.

27. The battery cell according to claim 26, wherein the raw material of the bonding layer further comprises at least one of the group consisting of sodium carboxymethyl cellulose and sodium alginate.

28. The battery cell according to claim 26, wherein the organic substance accounts for 10-100% of a total weight of the bonding layer in terms of weight percentage.

29. The battery cell according to claim 26, wherein the raw material of the bonding layer comprises inorganic substance, and the inorganic substance is selected from one or more of the group consisting of aluminum oxide, titanium oxide, zinc oxide, calcium oxide, magnesium oxide, zirconium oxide, and boehmite.

30. The battery cell according to claim 29, wherein a particle size D50 of the inorganic substance ranges from 0.1 to 2.0 μm.

31. The battery cell according to claim 29, wherein the inorganic substance accounts for 0-90% of the total weight of the bonding layer in terms of weight percentage.

32. The battery cell according to claim 20, wherein
the porous base film is of a single layer; and material of the porous base film is selected from one or more of the group consisting of polyethylene, polypropylene, polyethylene terephthalate, polyamide, polyimide, and PET non-woven fabric; or
the porous base film is of a multilayer; and the porous base film is made of polyethylene and/or polypropylene with different molecular weights and different melt indexes.

33. The battery cell according to claim 32, wherein a thickness of the porous base film is in the range of 5 μm to 30 μm.

34. The battery cell according to claim 32, wherein a porosity of the porous base film is in a range of 20% to 70%.

35. A power lithium battery, comprising the battery cell according to claim 20.
